(19) United States
(12) Patent Application Publication
(10) Pub. No.: US 2020/0256689 A1
(43) Pub. Date: Aug. 13, 2020

(54) ROUTE SEARCHING DEVICE, ROUTE SEARCHING SYSTEM, AND ROUTE SEARCHING METHOD

(71) Applicant: Mitsubishi Electric Corporation, Tokyo (JP)

(72) Inventor: Masanobu OSAWA, Tokyo (JP)

(73) Assignee: Mitsubishi Electric Corporation, Tokyo (JP)

(21) Appl. No.: 16/753,507

(22) PCT Filed: Dec. 4, 2017
(86) PCT No.: PCT/JP2017/043498

§ 371 Date: Apr. 3, 2020

(51) Int. Cl. G01C 21/34; B60W 50/16; B60W 60/00

(52) U.S. Cl. CPC G01C 21/3476; B60W 60/0013; G01C 21/343; B60W 50/16

(57) ABSTRACT

A route searching device searches for a travel route for a self-driving vehicle, and includes a route searching unit for searching for a first travel route, an action plan information acquiring unit for acquiring action plan information for an occupant in the vehicle, a vibration point information acquiring unit for acquiring vibration point information in the first travel route, and a determining unit for determining whether there is a point to be bypassed among one or more vibration points in the first travel route by using the action plan information and the vibration point information. When the determining unit determines that there is a point to be bypassed, the route searching unit searches for a second travel route bypassing the point to be bypassed.

### TECHNICAL FIELD

The present disclosure relates to a route searching device, a route searching system, and a route searching method.

### BACKGROUND ART

Conventionally, a technique of searching for a travel route bypassing points at each of which vibrations of a vehicle occur at the time of travel (referred to as “vibration points” hereinafter) in a route searching device used for vehicles has been developed. For example, a route searching device described in Patent Literature 1 searches for a travel route bypassing vibration points when a pregnant woman or an infant is in the vehicle.

### CITATION LIST

### Patent Literature

Patent Literature 1: JP 2007-10634 A

### SUMMARY OF INVENTION

### Technical Problem

In recent years, vehicles that automatically perform traveling control, i.e., so-called “automatic traveling vehicles” have been developed. Particularly, automatic traveling vehicles that eliminate the necessity for an occupant to monitor the traveling state, i.e., so-called “self-driving vehicles” have been developed.

In such a self-driving vehicle, the inside of the vehicle is space similar to a dwelling or an office, e.g. , space in which chairs are arranged around a table, like a dining room.

Occupants in a self-driving vehicle can have a meal in the vehicle in the same way that they have a meal at their homes, or can create documents in the vehicle in the same way that they create documents in their offices. More specifically, occupants in a self-driving vehicle can perform various actions in the vehicle.

However, when a self-driving vehicle travels through a vibration point, vibrations that does not occur in a house or an office occur. A problem is that these vibrations cause reduction in the comfortableness, the working efficiency, or the like at the time of an action in the vehicle. Further, a problem with the route searching device described in Patent Literature 1 is that because the route searching device does not search for a travel route bypassing vibration points in consideration of an action of an occupant in the self-driving vehicle, reduction in the comfortableness, the working efficiency, or the like cannot be suppressed.

The present disclosure is made in order to solve the above-mentioned problems, and it is therefore an object of the present disclosure to provide a route searching device, a route searching system, and a route searching method capable of searching for a travel route bypassing vibration points in accordance with an action plan of an occupant in a self-driving vehicle.

### Solution to Problem

A route searching device of the present disclosure searches for a travel route for a self-driving vehicle, and includes: a route searching unit for searching for a first travel route; an action plan information acquiring unit for acquiring action plan information for an occupant in the vehicle; a vibration point information acquiring unit for acquiring vibration point information in the first travel route; and a determining unit for determining whether there is a point to be bypassed among one or more vibration points in the first travel route by using the action plan information and the vibration point information. When the determining unit determines that there is a point to be bypassed, the route searching unit searches for a second travel route bypassing the point to be bypassed.

### Advantageous Effects of Invention

According to the present disclosure, because the route searching device is configured as above, a travel route bypassing vibration points can be searched for in accordance with an action plan of an occupant in the self-driving vehicle.

### BRIEF DESCRIPTION OF DRAWINGS

FIG. 1 is a block diagram showing a state in which a route searching device according to Embodiment 1 of the present disclosure is disposed in an HMI unit used for a self-driving vehicle;

FIG. 2 is an explanatory drawing showing an example of action plan information;

FIG. 3 is an explanatory drawing showing an example of bypass determination values;

FIG. 4A is a block diagram showing a hardware configuration of the route searching device according to Embodiment 1 of the present disclosure;

FIG. 4B is a block diagram showing another hardware configuration of the route searching device according to Embodiment 1 of the present disclosure;

FIG. 5 is a flowchart showing an operation of the route searching device according to Embodiment 1 of the present disclosure;

FIG. 6 is a flowchart showing the details of an operation of a determining unit of the route searching device according to Embodiment 1 of present disclosure;

FIG. 7 is a block diagram showing a state in which the route searching device according to Embodiment 1 of the present disclosure is disposed in a server device;

FIG. 8 is a block diagram showing a state in which a route searching device according to Embodiment 2 of the present disclosure is disposed in an HMI unit used for a self-driving vehicle;

FIG. 9 is an explanatory drawing showing an example of adjustment information;

FIG. 10 is a flowchart showing the details of an operation of a determining unit of the route searching device according to Embodiment 2 of present disclosure;

FIG. 11 is a flowchart showing the details of another operation of the determining unit of the route searching device according to Embodiment 2 of present disclosure; and

FIG. 12 is a block diagram showing a state in which a route searching device according to Embodiment 3 of the present disclosure is disposed in an HMI unit used for a self-driving vehicle.

### DESCRIPTION OF EMBODIMENTS

Hereinafter, in order to explain the present disclosure in greater detail, embodiments of the present disclosure will be described with reference to the accompanying drawings.

### Embodiment 1.

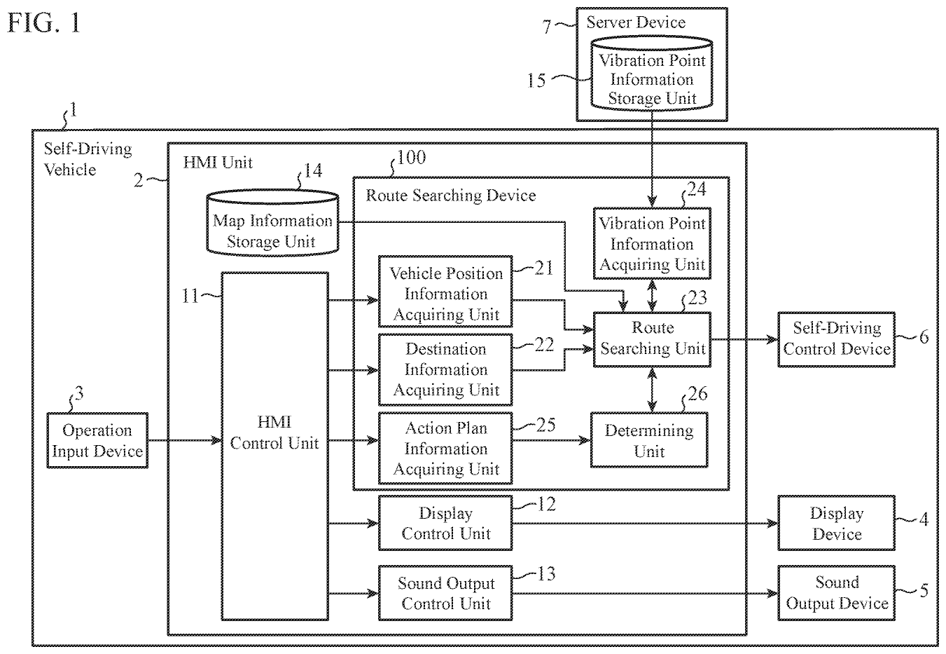

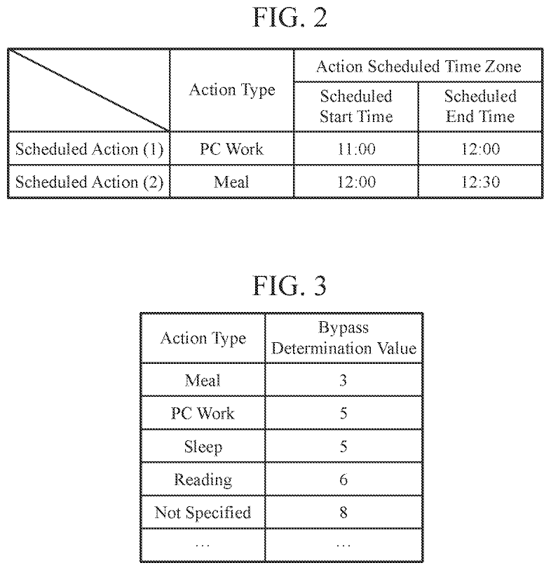

FIG. 1 is a block diagram showing a state in which a route searching device according to Embodiment 1 is disposed in a human machine interface (HMI) unit used for a self-driving vehicle. FIG. 2 is an explanatory drawing showing an example of action plan information. FIG. 3 is an explanatory drawing showing an example of bypass determination values. Referring to FIGS. 1 to 3, the route searching device 100 of Embodiment 1 will be explained by focusing on an example in which the route searching device is disposed in the HMI unit 2 used for the self-driving vehicle 1.

An operation input device 3 receives input of an operation by an occupant in the self-driving vehicle 1 (simply referred to as an “occupant” hereinafter), and outputs a signal corresponding to the operation (referred to as an “operation signal” hereinafter) to an HMI control unit 11.

The operation input device 3 includes, for example, hardware keys, a touch panel, or a voice recognition device. The voice recognition device recognizes an uttered voice of an occupant, the uttered voice being collected by a microphone, and outputs an operation signal corresponding to this uttered voice. The operation input device 3 maybe disposed integrally with the steering wheel or the like of the self-driving vehicle 1 or may be disposed as a discrete device.

The HMI control unit 11 receives input of the operation signal, and outputs a signal to order performance of one of various control operations (referred to as an “order signal” hereinafter), or the like. Concretely, for example, the HMI control unit 11 outputs an order signal to order a search for a travel route to the route searching device 100, outputs an order signal to order display of one of various screens to a display control unit 12, outputs an order signal to order output of one of various sounds to a sound output control unit 13, or outputs an order signal to order an operation of an air conditioner (not illustrated) to a control device (not illustrated) used for the air conditioner.

The display control unit 12 performs control to cause a display device 4 to display one of various screens in accordance with an order signal. Concretely, for example, the display control unit 12 causes the display device 4 to display an operation screen or the like used for vehicle-mounted information equipment (not illustrated). The display device 4 includes, for example, a liquid crystal display or an organic electro luminescence (EL) display integral with vehicle-mounted information equipment, or a head-up display (HUD) mounted in the self-driving vehicle 1.

The sound output control unit 13 performs control to cause a sound output device 5 to output one of various sounds in accordance with an order signal. Concretely, for example, the sound output control unit 13 causes the sound output device 5 to output a sound played back by an audio playback device (not illustrated) . The sound output device 5 includes, for example, a speaker mounted in the self-driving vehicle 1.

The route searching device 100 searches for a travel route for the self-driving vehicle 1 in accordance with an order signal. At this time, the route searching device 100 searches for a travel route by using map information stored in a map information storage unit 14. The route searching device 100 outputs information representing the searched-for travel route (referred to as “route information” hereinafter) to a self-driving control device 6.

The self-driving control device 6 controls each unit of the self-driving vehicle 1 in such a way that the self-driving vehicle 1 travels along the travel route represented by the route information. More specifically, the self-driving vehicle 1 travels along the travel route searched for by the route searching device 100 by means of so-called “self-driving” under the control of the self-driving control device 6. The self-driving control device 6 includes, for example, an electronic control unit (ECU) mounted in the self-driving vehicle 1.

The map information storage unit 14 stores the map information used for a search for a travel route by the route searching device 100. The map information storage unit 14 includes, for example, an auxiliary storage device such as a hard disk drive (HDD) or a solid state drive (SSD).

The map information represents a road network by using nodes and links. More specifically, each node corresponds to a nodal point (e.g., an intersection) in a road network, and each link corresponds to a road section between nodal points. As the data structure of the map information, well-known various types of data structure can be used, and a detailed explanation will be omitted hereinafter.

A vibration point information storage unit 15 stores information about points at each of which vibrations occur in the vehicle at the time of travel, i.e., vibration points (referred to as “vibration point information” hereinafter). The vibration point information storage unit 15 includes, for example, an auxiliary storage device such as an HDD or an SSD.

The vibration point information represents at least the position of each vibration point and a level corresponding to the magnitude of vibrations which are to occur at the vibration point (referred to as a “vibration level” hereinafter). It is assumed hereinafter that the magnitude of vibrations which are to occur at each vibration point is expressed by the acceleration in the vertical direction. The vibration level is expressed by, for example, a value in one of ten levels, and a preset acceleration range is assigned to each of the levels. More specifically, a higher acceleration level value indicates that larger vibrations in the vertical direction are to occur at the vibration point.

The vibration point information is generated using, for example, pieces of probe information uploaded from multiple vehicles to a server device 7. More specifically, an acceleration sensor, a wireless communication device, a global positioning system (GPS) receiver, and so on are disposed in each of the multiple vehicles. Each of the multiple vehicles transmits information representing the acceleration in the vertical direction detected by the acceleration sensor, and information representing the position of a point at which the acceleration is detected to the server device 7. The server device 7 generates the vibration point information by using these pieces of information. In the example shown in FIG. 1, the vibration point information storage unit 15 is disposed in the server device 7.

Hereinafter, main units of the route searching device 100 will be explained.

A vehicle position information acquiring unit 21 acquires information representing the current position of the self-driving vehicle 1 (referred to as “vehicle position information” hereinafter), and outputs the vehicle position information to a route searching unit 23. The current position of the self-driving vehicle 1 is referred to as the “vehicle position” hereinafter. The vehicle position information is generated using, for example, GPS signals that a GPS receiver (not illustrated) mounted in the self-driving vehicle 1 receives. The vehicle position information acquiring unit 21 acquires the vehicle position information from, for example, the HMI control unit 11.

A destination information acquiring unit 22 acquires information representing the position of a destination of the self-driving vehicle 1 (referred to as “destination information” hereinafter), and outputs the destination information to the route searching unit 23. This destination is set through an operation on the operation input device 3 in a state in which, for example, a screen for destination setting is displayed on the display device 4. The destination information acquiring unit 22 acquires the destination information from, for example, the HMI control unit 11.

The route searching unit 23 searches for a travel route from the vehicle position to the destination (referred to as a “first travel route” hereinafter) by using the map information, the vehicle position information, and the destination information. The route searching unit 23 outputs route information representing the first travel route to a vibration point information acquiring unit 24 and a determining unit 26.

For example, a well-known Dijkstra method is used for a search for the first travel route. More specifically, as to each of multiple travel routes from the vehicle position to the destination, the route searching unit 23 sums up the passing costs of the links and the nodes included in the travel route. The route searching unit 23 selects, as the first travel route, the travel route having the smallest sum out of the multiple travel routes.

The vibration point information acquiring unit 24 acquires the vibration point information about the vibration points in the first travel route (referred to as the “vibration point information in the first travel route” hereinafter) out of the vibration point information stored in the vibration point information storage unit 15 by using the route information representing the first travel route. At this time, the vibration point information acquiring unit 24 acquires the vibration point information in the first travel route via communication units (not illustrated) disposed in the HMI unit 2 and in the server device 7. The vibration point information acquiring unit 24 outputs the vibration point information in the first travel route to the determining unit 26.

An action plan information acquiring unit 25 acquires information representing an action plan of an occupant in the self-driving vehicle 1 (referred to as “action plan information” hereinafter), and outputs the action plan information to the determining unit 26. This action plan is inputted through an operation on the operation input device 3 in a state in which, for example, a screen for action plan input is displayed on the display device 4. The action plan information acquiring unit 25 acquires the action plan information from, for example, the HMI control unit 11.

The action plan information represents at least an action type and an action scheduled time zone (more concretely, a scheduled start time and a scheduled end time) that are associated with each scheduled action. An example of the action plan information is shown in FIG. 2.

The determining unit 26 determines whether there is a vibration point that should be bypassed (referred to as a “point to be bypassed” hereinafter) among the vibration points in the first travel route by using the route information representing the first travel route, the vibration point information in the first travel route, and the action plan information. The determining unit 26 outputs a result of the determination to the route searching unit 23. When it is determined that there is a point to be bypassed, the determination result outputted from the determining unit 26 to the route searching unit 23 includes information representing the point to be bypassed (referred to as “point to be bypassed information” hereinafter).

Concretely, for example, a bypass determination value corresponding to each of action types that can be included in the action plan information is stored in advance in the determining unit 26. This bypass determination value is a threshold used for determination of whether or not a vibration point should be bypassed, and serves as an object for comparison with a vibration level value. An example of bypass determination values is shown in FIG. 3.

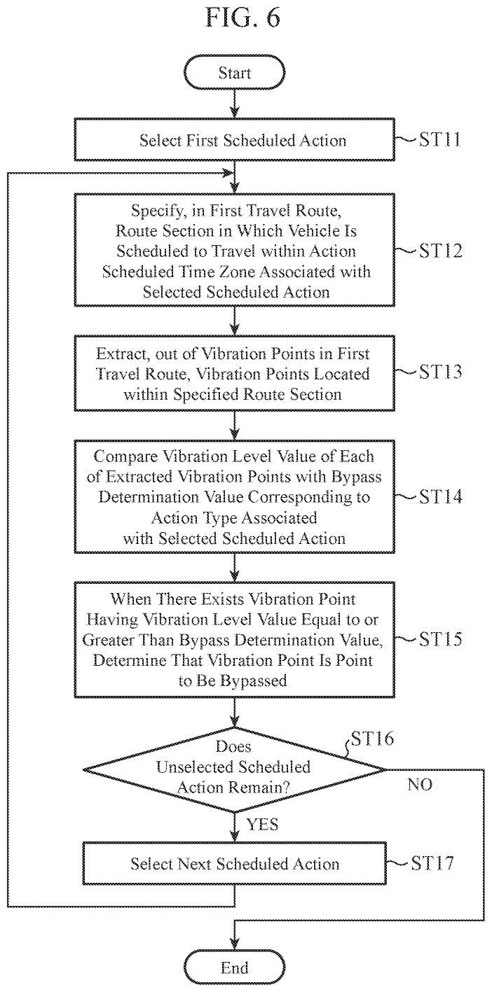

When, for each scheduled action included in the action plan information, there exists a vibration point that causes vibrations having a vibration level equal to or greater than the bypass determination value corresponding to the action type associated with the scheduled action to occur in the self-driving vehicle 1 at a time within the action scheduled time zone associated with the scheduled action, the determining unit 26 determines that the vibration point is a point to be bypassed. The details of the processing by the determining unit 26 will be mentioned later by referring to a flowchart of FIG. 6.

Here, the bypass determination value corresponding to each action type is preset depending on the magnitude of the influence of vibrations of the self-driving vehicle 1 on the comfortableness at the time of the action, the magnitude of the influence of vibrations of the self-driving vehicle 1 on the working efficiency at the time of the action, the ease of recovery from an event occurring as a result of vibrations of the self-driving vehicle 1, or the like.

For example, in the example shown in FIG. 3, the bypass determination value corresponding to an action type “meal” is set to a relatively small value (3 out of the ten levels). This is because there is a high probability that when vibrations of the self-driving vehicle 1 occur during a meal, the vibrations may cause dishes to come into contact with each other, and a sound caused by this contact provides occupants with displeasure. Further, this is because when a dish falls off a table in the vehicle because of the vibrations and thereby breaks or when food falls because of the vibrations and thereby the inside of the vehicle becomes dirty, it is difficult to return to the original state.

On the other hand, in the example shown in FIG. 3, the bypass determination value corresponding to an action type “reading” is set to a relatively large value (6 out of the ten levels). This is because even though vibrations of the self-driving vehicle 1 occur during reading, the influence of the vibrations on the reading speed is small when the vibrations are small. Further, this is because it is considered that a situation that is difficult to return to the original state does not occur in the case of the action type “reading”, unlike in the case of the action type “meal.”

The route searching unit 23 searches for a travel route that extends from the vehicle position to the destination and that bypasses the point to be bypassed (referred to as a “second travel route” hereinafter) by using the map information, the vehicle position information, the destination information, and the point to be bypassed information. Concretely, for example, the route searching unit 23 sets the passing cost of the link corresponding to the road section including the point to be bypassed to be higher than the passing cost of the link at the time of the search for the first travel route, and then searches for a second travel route by using a Dijkstra method.

When the determining unit 26 determines that there is no point to be bypassed, the route searching unit 23 outputs the route information representing the first travel route to the self-driving control device 6, whereas when the determining unit 26 determines that there is a point to be bypassed, the route searching unit 23 outputs the route information representing the second travel route to the self-driving control device 6. As a result, under the control of the self-driving control device 6, the self-driving vehicle 1 travels either the travel route in which no point to be bypassed exists (first travel route) or the travel route in which the point to be bypassed is bypassed (second travel route) . As a result, comfortable space in the vehicle can be provided for occupants.

The main units of the route searching device 100 include the vehicle position information acquiring unit 21, the destination information acquiring unit 22, the route searching unit 23, the vibration point information acquiring unit 24, the action plan information acquiring unit 25, and the determining unit 26.

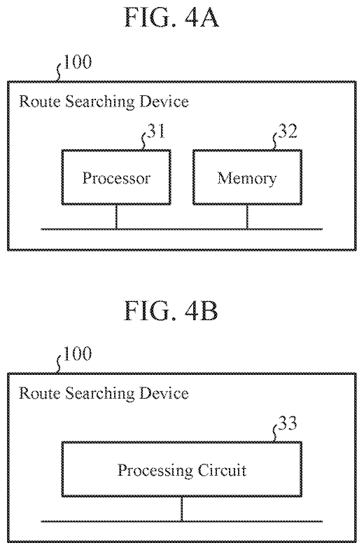

Next, the hardware configuration of the main units of the route searching device 100 will be explained by referring to FIG. 4.

As shown in FIG. 4A, the route searching device 100 includes a computer, and has a processor 31 and a memory 32. In the memory 32, a program to cause the computer to function as the vehicle position information acquiring unit 21, the destination information acquiring unit 22, the route searching unit 23, the vibration point information acquiring unit 24, the action plan information acquiring unit 25, and the determining unit 26 is stored. The processor 31 reads and executes the program stored in the memory 32, thereby implementing the functions of the vehicle position information acquiring unit 21, the destination information acquiring unit 22, the route searching unit 23, the vibration point information acquiring unit 24, the action plan information acquiring unit 25, and the determining unit 26.

As the processor 31, for example, a central processing unit (CPU), a graphics processing unit (GPU), a microprocessor, a microcontroller, or a digital signal processor (DSP) is used. As the memory 32, for example, a semiconductor memory, such as a random access memory (RAM), a read only memory (ROM), a flash memory, an erasable programmable read only memory (EPROM), and an electrically erasable programmable read-only memory (EEPROM), a magnetic disc, an optical disc, ora magneto-optical disc is used.

As an alternative, as shown in FIG. 4B, the functions of the vehicle position information acquiring unit 21, the destination information acquiring unit 22, the route searching unit 23, the vibration point information acquiring unit 24, the action plan information acquiring unit 25, and the determining unit 26 may be implemented by a processing circuit 33. As the processing circuit 33, for example, an application specific integrated circuit (ASIC), a programmable logic device (PLD), a field-programmable gate array (FPGA), a system-on-a-chip (SoC), or a system large-scale integration (LSI) is used.

Because the hardware configuration of the HMI control unit 11, the display control unit 12, and the sound output control unit 13 is the same as that shown in FIG. 4A or 4B, an illustration and an explanation of the hardware configuration will be omitted.

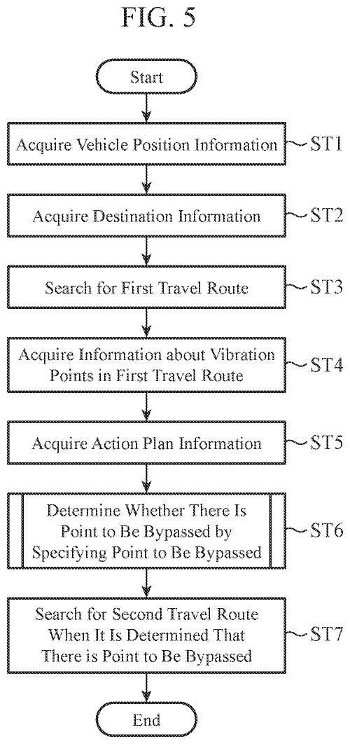

Next, the operation of the route searching device 100 will be explained by referring to a flowchart of FIG. 5. The route searching device 100 performs processes in steps ST1 to ST7 mentioned below in accordance with an order signal to order a search for a travel route.

First, in step ST1, the vehicle position information acquiring unit 21 acquires the vehicle position information from the HMI control unit 11. The vehicle position information acquiring unit 21 outputs the vehicle position information to the route searching unit 23.

Then, in step ST2, the destination information acquiring unit 22 acquires the destination information from the HMI control unit 11. The destination information acquiring unit 22 outputs the destination information to the route searching unit 23.

Then, in step ST3, the route searching unit 23 searches for a first travel route from the vehicle position to the destination by using the map information, the vehicle position information, and the destination information. The route searching unit 23 outputs route information representing the first travel route to the vibration point information acquiring unit 24 and the determining unit 26.

Then, in step ST4, the vibration point information acquiring unit 24 acquires the vibration point information in the first travel route out of the vibration point information stored in the vibration point information storage unit 15, by using the route information representing the first travel route. The vibration point information acquiring unit 24 outputs the vibration point information in the first travel route to the determining unit 26.

Then, in step ST5, the action plan information acquiring unit 25 acquires the action plan information from the HMI control unit 11. The action plan information acquiring unit 25 outputs the action plan information to the determining unit 26.

Then, in step ST6, the determining unit 26 determines whether there is a point to be bypassed among the vibration points in the first travel route, by using the route information representing the first travel route, the vibration point information in the first travel route, and the action plan information.

More specifically, when, for each scheduled action included in the action plan information, there exists a vibration point that causes vibrations having a vibration level equal to or greater than the bypass determination value corresponding to the action type associated with the scheduled action to occur in the self-driving vehicle 1 at a time within the action scheduled time zone associated with the scheduled action, the determining unit 26 determines that the vibration point is a point to be bypassed. The details of the process of step ST6 will be mentioned later by referring to the flowchart of FIG. 6.

Then, instep ST7, when the determining unit 26 determines that there is a point to be bypassed, the route searching unit 23 searches for a second travel route that bypasses the point to be bypassed by using the map information, the vehicle position information, the destination information, and the point to be bypassed information.

Next, the details of the process of step ST6 by the determining unit 26 will be explained by referring to the flowchart of FIG. 6.

First, in step ST11, the determining unit 26 selects one scheduled action (in the flowchart, a “first scheduled action”) out of the scheduled actions included in the action plan information.

Then, in step ST12, the determining unit 26 specifies, in the first travel route, a route section in which the vehicle is scheduled to travel within the action scheduled time zone associated with the scheduled action selected in step ST11.

Then, in step ST13, the determining unit 26 extracts, out of the vibration points in the first travel route, the vibration points located within the route section specified in step ST12.

Then, in step ST14, the determining unit 26 compares the vibration level value of each of the vibration points extracted in step ST13 with the bypass determination value corresponding to the action type associated with the scheduled action selected in step ST11.

Then, in step ST15, when a result of the comparison in step ST14 shows that there exists a vibration point having a vibration level value equal to or greater than the bypass determination value, the determining unit 26 determines that the vibration point is a point to be bypassed. At this time, the determining unit 26 determines that any vibration point having a vibration level value less than the bypass determination value is not a point to be bypassed.

Then, in step ST16, the determining unit 26 determines whether there remain one or more scheduled actions that have not been selected, in the scheduled actions included in the action plan information.

When there remain one or more scheduled actions that have not been selected (“YES” in step ST16), the determining unit 26, in step ST17, selects one scheduled action (in the flowchart, the “next scheduled action”) out of the scheduled actions that have not been selected. After that, the determining unit 26 performs the processes of steps ST12 to ST15 on the scheduled action selected in step ST17.

In contrast, when all the scheduled actions have been selected (“NO” in step ST16), the processing by the determining unit 26 is ended.

By searching for a travel route that bypasses a vibration point (second travel route) in accordance with an action plan of an occupant in the self-driving vehicle 1 in this way, reduction in the comfortableness, the working efficiency, and so on at the time of an action because of vibrations can be prevented.

Further, by setting a bypass determination value for each of the action types in consideration of the influence of vibrations of the self-driving vehicle 1 on the comfortableness, the working efficiency, or the like at the time of an action, and so on, instead of setting the same bypass determination value for all the action types, increase in the number of points to be bypassed can be suppressed. Therefore, increase in the travel time to the destination can be suppressed. More specifically, while increase in the travel time because of bypassing of many vibration points is suppressed, reduction in the comfortableness, the working efficiency, or the like at the time of an action in the vehicle because of vibrations can be prevented.

The vibration point information may represent, instead of the vibration level in the vertical direction at each vibration point, the acceleration in the vertical direction detected at each vibration point. In this case, the bypass determination value may be an object for comparison with the acceleration value in the vertical direction.

Further, information representing occupants' daily action patterns may be stored in a server device, and the server device may generate action plan information by using the stored information and the action plan information acquiring unit 25 may acquire the generated action plan information from the server device. This server device may be the server device 7 shown in FIG. 1 or another server device (not illustrated) . The information representing occupants' daily action patterns is collected by, for example, wearable devices that the occupants daily wear.

Further, the determination by the determining unit 26 may be any of determination of “whether or not . . . is equal to or greater than . . . , or less than . . . ” and determination of “whether or not . . . is greater than . . . , or equal to or less than . . . ” More specifically, when, for each scheduled action included in the action plan information, there exists a vibration point that causes vibrations having a vibration level greater than the bypass determination value corresponding to the action type associated with the scheduled action to occur in the self-driving vehicle 1 at a time within the action scheduled time zone associated with the scheduled action, the determining unit 26 may determine that the vibration point is a point to be bypassed. More concretely, when a result of the comparison in step ST14 shows that there exists a vibration point having a vibration level value greater than the bypass determination value, the determining unit 26 may determine that the vibration point is a point to be bypassed. The term “a vibration level equal to or greater than the bypass determination value” described in the claims of this application includes not only the meaning of “a vibration level equal to or greater than the bypass determination value” but also the meaning of “a vibration level greater than the bypass determination value.”

Further, the vibration point information may represent, in addition to the vibration level in the vertical direction at each vibration point, the vibration level in the front-back direction at each vibration point. As an alternative, the vibration point information may represent, in addition to the acceleration in the vertical direction detected at each vibration point, the acceleration in the front-back direction detected at each vibration point. The determining unit 26 may store, for each action type, not only the bypass determination value that is an object for comparison with the vibration level value or the acceleration value in the vertical direction, but also a bypass determination value that is an object for comparison with the vibration level value or the acceleration value in the front-back direction.

Further, the vibration point information may represent, in addition to the vibration level in the vertical direction at each vibration point, the vibration level in the left-right direction at each vibration point. As an alternative, the vibration point information may represent, in addition to the acceleration in the vertical direction detected at each vibration point, the acceleration in the left-right direction detected at each vibration point. The determining unit 26 may store, for each action type, not only the bypass determination value that is an object for comparison with the vibration level value or the acceleration value in the vertical direction, but also a bypass determination value that is an object for comparison with the vibration level value or the acceleration value in the left-right direction.

More specifically, a vibration point where vibrations in the vertical direction occur is a point where vibrations of a vehicle occur because of the projections and depressions of a road surface, or the like. A vibration point where vibrations in the front-back direction occur is a point where vibrations of a vehicle occur because of sudden braking or the like. A vibration point where vibrations in the left-right direction occur is a point where vibrations of a vehicle occur because of a sharp curve or the like. By including, in addition to vibration points at each of which vibrations in the vertical direction occur, vibration points at each of which vibrations in the front-back direction or the left-right direction occur into targets to be bypassed, the comfortableness, the working efficiency, or the like at the time of an action in the vehicle can be improved.

Further, when, for each scheduled action included in the action plan information, there exist vibration points that cause vibrations having vibration levels equal to or greater than the bypass determination value (or vibration levels greater than the bypass determination value) corresponding to the action type associated with the scheduled action to continuously occur in the self-driving vehicle 1 over a predetermined time period (e.g., five seconds) within the action scheduled time zone associated with the scheduled action, the determining unit 26 may determine that the vibration points are points to be bypassed.

More specifically, among the action types, there is an action type such as “reading” in which, even though vibrations of the self-driving vehicle 1 occur, the comfortableness is not impaired when the vibrations have occurred singly. Accordingly, in a case in which, for example, a scheduled action associated with such an action type is selected in step Sill or ST17, even though a result of the comparison in step ST14 shows that there exist vibration points having vibration level values equal to or greater than the bypass determination value, the determining unit 26 determines that the vibration points are not points to be bypassed when the vibration points are not a predetermined number (e.g., 10) or more continuous points.

The predetermined time period in this case (i.e., the predetermined number) may be set for each action type in accordance with the degree of reduction or the like in the comfortableness, the working efficiency, or the like with respect to the length of the continuous time of vibrations. More specifically, the predetermined time period is not limited to 5 seconds, and the predetermined number is not limited to 10.

Further, what is necessary is just to dispose each functional unit in the route searching device 100 (i.e., each of the following units: the vehicle position information acquiring unit 21, the destination information acquiring unit 22, the route searching unit 23, the vibration point information acquiring unit 24, the action plan information acquiring unit 25, and the determining unit 26) in one of certain vehicle-mounted information equipment mounted in the self-driving vehicle 1, a certain mobile information terminal that can be carried into the self-driving vehicle 1 (e.g., a smartphone) , and a server device that can communicate with the self-driving vehicle 1. Thus, the disposition is not limited to the example in which all these functional units are disposed in the HMI unit 2 as shown in FIG. 1.

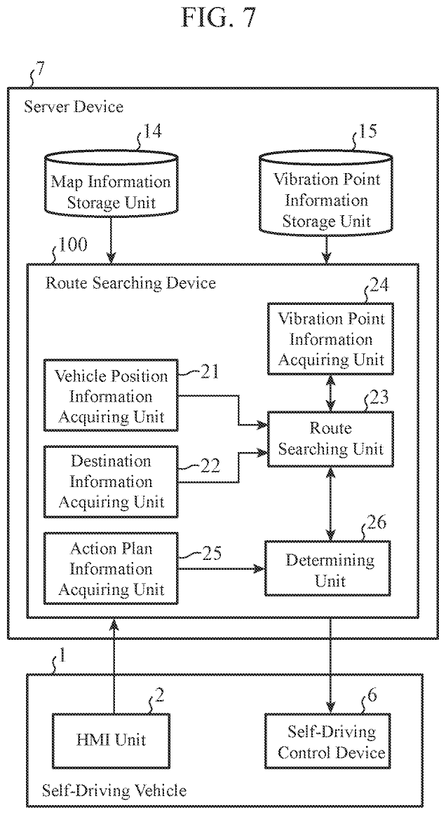

For example, as shown in FIG. 7, all these functional units may be disposed in the server device 7. In the example shown in FIG. 7, the map information storage unit 14 is also disposed in the server device 7.

As an alternative, for example, these functional units may be disposed distributedly in two or more of the vehicle-mounted information equipment, the mobile information terminal, and the server device. More specifically, a route searching system used for the self-driving vehicle 1 may include two or more of the vehicle-mounted information equipment, the mobile information terminal, and the server device.

As mentioned above, the route searching device 100 of Embodiment 1 searches for a travel route for the self-driving vehicle 1, and includes the route searching unit 23 that searches for a first travel route, the action plan information acquiring unit 25 that acquires action plan information for an occupant in the vehicle, the vibration point information acquiring unit 24 that acquires vibration point information in the first travel route, and the determining unit 26 that determines whether there is a point to be bypassed among the vibration points in the first travel route by using the action plan information and the vibration point information. When the determining unit 26 determines that there is a point to be bypassed, the route searching unit 23 searches for a second travel route that bypasses the point to be bypassed. By searching for a travel route that bypasses vibration points (second travel route) in accordance with the action plan of an occupant in the self-driving vehicle 1, reduction in the comfortableness, the working efficiency, and so on because of vibrations at the time of an action in the vehicle can be prevented.

Further, the action plan information represents the action type and the action scheduled time zone of each scheduled action, and the vibration point information represents the position and the vibration level of each vibration point. When, for each scheduled action, there exists a vibration point that causes vibrations having a vibration level equal to or greater than the bypass determination value that is set in accordance with the action type to occur in the self-driving vehicle 1 at a time within the action scheduled time zone, the determining unit 26 determines that the vibration point is a point to be bypassed. By using the bypass determination value set for each action type, increase in the travel time can be suppressed while reduction in the comfortableness, the working efficiency, or the like at the time of an action is prevented.

Further, the action plan information represents the action type and the action scheduled time zone of each scheduled action, and the vibration point information represents the position and the vibration level of each vibration point. When, for each scheduled action, there exist vibration points that cause vibrations having vibration levels equal to or greater than the bypass determination value that is set in accordance with the action type to continuously occur in the self-driving vehicle 1 over a predetermined time period within the action scheduled time zone, the determining unit 26 determines that the vibration points are points to be bypassed. By excluding, as to a scheduled action associated with an action type such as “reading”, a vibration point which causes vibrations to occur singly from the targets to be bypassed, increase in the travel time can be suppressed while reduction in the comfortableness, the working efficiency, or the like at the time of an action is prevented.

Further, the route searching system of Embodiment 1 searches for a travel route for the self-driving vehicle 1, and includes the route searching unit 23 that searches for a first travel route, the action plan information acquiring unit 25 that acquires action plan information for an occupant in the vehicle, the vibration point information acquiring unit 24 that acquires vibration point information in the first travel route, and the determining unit 26 that determines whether there is a point to be bypassed among the vibration points in the first travel route by using the action plan information and the vibration point information. When the determining unit 26 determines that there is a point to be bypassed, the route searching unit 23 searches for a second travel route that bypasses the point to be bypassed. As a result, the same advantages as the above-mentioned advantages provided by the route searching device 100 can be provided.

Further, the route searching method of Embodiment 1 is a method of searching for a travel route for the self-driving vehicle 1, and includes step ST3 of, in the route searching unit 23, searching for a first travel route, step ST5 of, in the action plan information acquiring unit 25, acquiring action plan information for an occupant in the vehicle, step ST4 of, in the vibration point information acquiring unit 24, acquiring vibration point information in the first travel route, step ST6 of, in the determining unit 26, determining whether there is a point to be bypassed among the vibration points in the first travel route by using the action plan information and the vibration point information, and step ST7 of, in the route searching unit 23, when the determining unit 26 determines that there is a point to be bypassed, searching for a second travel route that bypasses the point to be bypassed. As a result, the same advantages as the above-mentioned advantages provided by the route searching device 100 can be provided.

### Embodiment 2

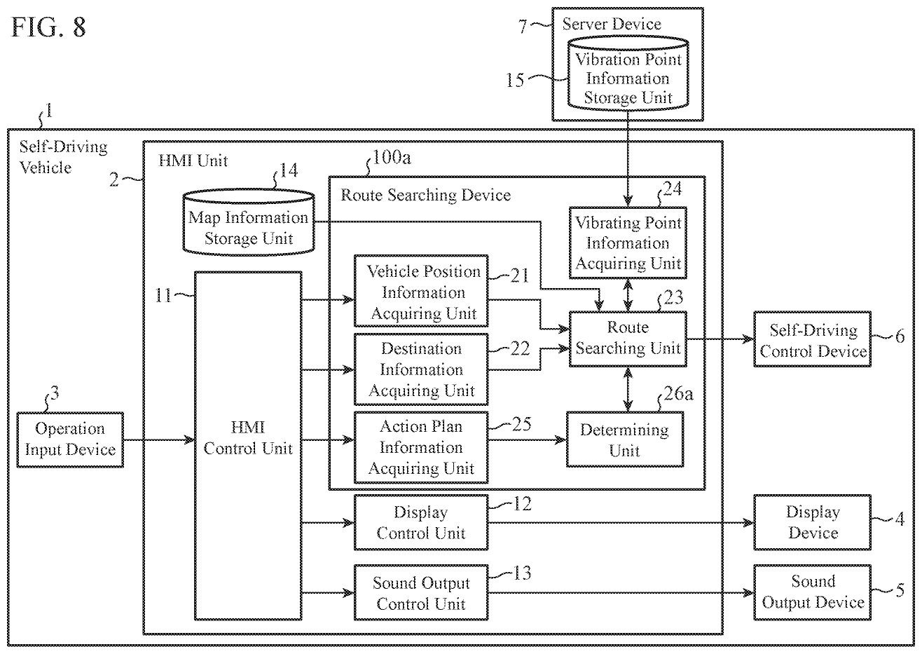

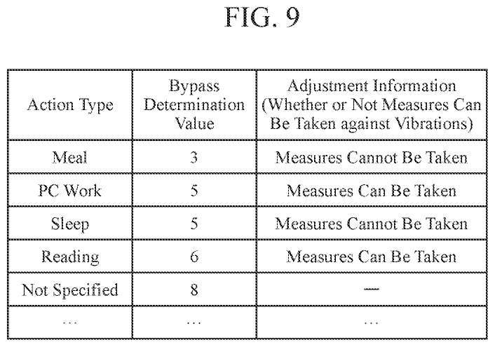

FIG. 8 is a block diagram showing a state in which a route searching device according to Embodiment 2 is disposed in an HMI unit used for a self-driving vehicle. FIG. 9 is an explanatory drawing showing an example of adjustment information. Referring to FIGS. 8 and 9, the route searching device 100a of Embodiment 2 will be explained by focusing on an example in which the route searching device is disposed in the HMI unit 2 used for the self-driving vehicle 1. In FIG. 8, the same blocks as those shown in FIG. 1 are denoted by the same reference signs, and an explanation of the blocks will be omitted hereinafter.

The determining unit 26 in the route searching device 100 of Embodiment 1 determines whether there is a point to be bypassed by using the route information representing the first travel route, the vibration point information in the first travel route, and the action plan information. A determining unit 26a in the route searching device 100a of Embodiment 2 determines whether there is a point to be bypassed by using, in addition to these pieces of information, other information (referred to as “adjustment information” hereinafter) different from the pieces of information.

More specifically, the adjustment information is information for adjusting the number of points to be bypassed, and more concretely, is information for reducing the number of points to be bypassed. Hereinafter, two concrete examples of the adjustment information and processing that is performed by the determining unit 26a by using the adjustment information will be explained.

### (First Concrete Example)

In the first concrete example, the adjustment information represents, for each action type, whether or not measures can be taken against vibrations. More concretely, the adjustment information represents whether, when an occupant is notified of the occurrence of vibrations in advance, the occupant can take measures against the vibrations (more specifically, whether or not reduction in the comfortableness, the working efficiency, or the like because of the vibrations can be prevented or reduced). An example of the adjustment information in the first concrete example is shown in FIG. 9. As shown in FIG. 9, in addition to a bypass determination value corresponding to each action type, the adjustment information representing, for each action type, whether or not measures can be taken against vibrations is stored in the determining unit 26a in advance.

In the example shown in FIG. 9, for an action type “PC work”, information representing that “measures can be taken” against vibrations is set. When a misoperation of a mouse or keyboard occurs because of vibrations and thereby input that an occupant does not intend to perform occurs while the occupant is performing work, such as generation of documentation, by using a personal computer (PC), the working efficiency is reduced because the occupant needs to correct the input. However, because the occupant can prevent the occurrence of such a misoperation by suspending the work temporarily when the occupant is notified of the occurrence of vibrations in advance, the reduction in the working efficiency because of the misoperation can be prevented. Therefore, for the action type “PC work”, the information representing that “measures can be taken” against vibrations is set.

In contrast, in the example shown in FIG. 9, for an action type “sleep”, information representing that “no measures can be taken” against vibrations is set. This is because when an occupant is sleeping, it is impossible to take measures against vibrations while preventing or reducing the degradation in the comfortableness even though the occupant is notified of the occurrence of the vibrations in advance.

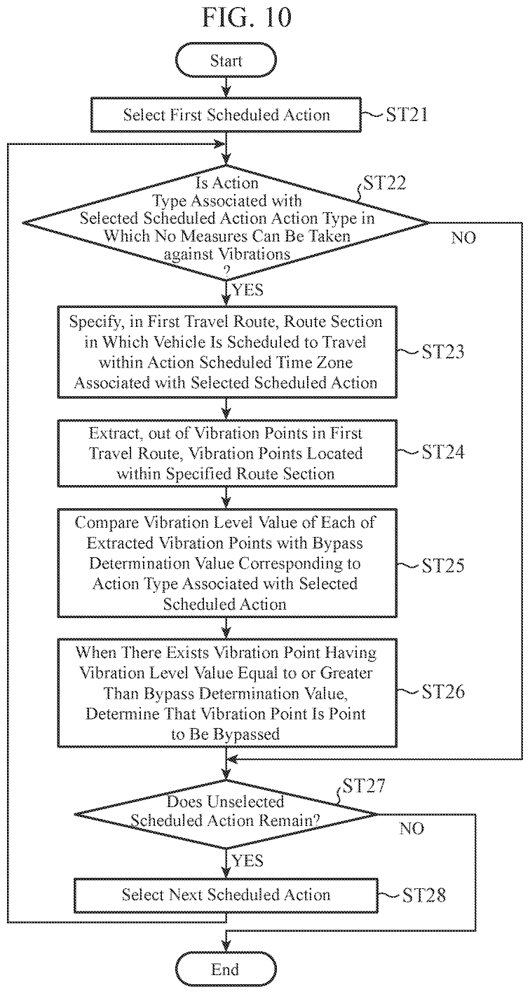

In the first concrete example, when, for each scheduled action associated with an action type in which no measures can be taken against vibrations, out of the scheduled actions included in the action plan information, there exists a vibration point that causes vibrations having a vibration level equal to or greater than the bypass determination value that is set in accordance with the action type associated with the scheduled action to occur in the self-driving vehicle 1 at a time within the action scheduled time zone associated with the scheduled action, the determining unit 26a determines that the vibration point is a point to be bypassed. The details of the processing performed by the determining unit 26a in the first concrete example will be mentioned later by referring to a flowchart of FIG. 10.

### (Second Concrete Example)

In the second concrete example, the adjustment information represents the probability of occurrence of vibrations at each vibration point. More specifically, the adjustment information in the second concrete example is included in the vibration point information, and is stored in a vibration point information storage unit 15.

For example, at a vibration point where vibrations in the vertical direction occur because of the projections and depressions of a road surface, or the like, vibrations of the self-driving vehicle 1 occur almost certainly irrespective of the travel speed, the traffic conditions, etc. Therefore, its vibration occurrence probability value is set to a high value. In contrast, at a vibration point where vibrations in the front-back direction occur because of sudden braking or the like, and at a vibration point where vibrations in the left-right direction occur because of a sharp curve or the like, there is a possibility that vibrations of the self-driving vehicle 1 do not occur depending on the travel speed, the traffic conditions, etc. Therefore, its vibration occurrence probability value is set to a low value.

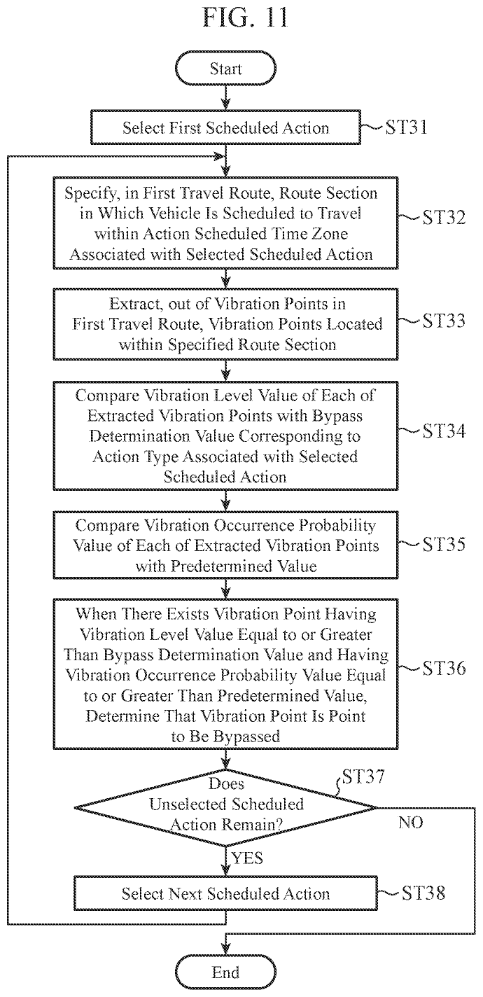

In the second concrete example, when, for each scheduled action included in the action plan information, there exists a vibration point that causes vibrations to occur with a probability equal to or higher than a predetermined probability (e.g., 50%), and that causes the vibrations having a vibration level equal to or greater than the bypass determination value that is set in accordance with the action type associated with the scheduled action to occur in the self-driving vehicle 1 at a time within the action scheduled time zone associated with the scheduled action, the determining unit 26a determines that the vibration point is a point to be bypassed. The details of the processing performed by the determining unit 26a in the second concrete example will be mentioned later by referring to a flowchart of FIG. 11.

Main units of the route searching device 100a include a vehicle position information acquiring unit 21, a destination information acquiring unit 22, a route searching unit 23, a vibration point information acquiring unit 24, an action plan information acquiring unit 25, and the determining unit 26a.

Further, because the hardware configuration of the main units of the route searching device 100a is the same as that explained by referring to FIG. 4 in Embodiment 1 , an illustration and an explanation of the hardware configuration will be omitted hereinafter.

Further, because the operation of the route searching device 100a is the same as that explained by referring to the flowchart of FIG. 5 in Embodiment 1 , an illustration and an explanation of the operation will be omitted hereinafter.

Next, the details of the processing performed by the determining unit 26a in the first concrete example will be explained by referring to the flowchart of FIG. 10.

First, in step ST21, the determining unit 26a selects one scheduled action (in the flowchart, a “first scheduled action”) out of the scheduled actions included in the action plan information.

Then, in step ST22, the determining unit 26a determines whether or not the action type associated with the scheduled action selected in step ST21 is an action type in which no measures can be taken against vibrations, by using the adjustment information stored in advance.

When the action type associated with the scheduled action selected in step ST21 is an action type in which no measures can be taken against vibrations (“YES” in step ST22), the determining unit 26a , in step ST23, specifies, in the first travel route, a route section in which the vehicle is scheduled to travel within the action scheduled time zone associated with the scheduled action selected in step ST21.

Then, in step ST24, the determining unit 26a extracts, out of the vibration points in the first travel route, the vibration points located within the route section specified in step ST23.

Then, in step ST25, the determining unit 26a compares the vibration level value of each of the vibration points extracted in step ST24 with the bypass determination value corresponding to the action type associated with the scheduled action selected in step ST21.

Then, in step ST26, when a result of the comparison in step ST25 shows that there exists a vibration point having a vibration level value equal to or greater than the bypass determination value, the determining unit 26a determines that the vibration point is a point to be bypassed. At this time, the determining unit 26a determines that any vibration point having a vibration level value less than the bypass determination value is not a point to be bypassed.

However, when the action type associated with the scheduled action selected in step ST21 is an action type in which measures can be taken against vibrations (“NO” in step ST22), the processes of steps ST23 to ST26 are skipped.

Then, in step ST27, the determining unit 26a determines whether there remain one or more scheduled actions that have not been selected, in the scheduled actions included in the action plan information.

When there remain one or more scheduled actions that have not been selected (“YES” in step ST27), the determining unit 26a , in step ST28, selects one scheduled action (in the flowchart, the “next scheduled action”) out of the scheduled actions that have not been selected. After that, the determining unit 26a performs the processes of steps ST22 to ST26 on the scheduled action selected in step ST28. However, in a case of “NO” in step ST22, the processes of steps ST23 to ST26 are skipped.

In contrast, when all the scheduled actions have been selected (“NO” in step ST27), the processing by the determining unit 26a is ended.

Next, the details of the processing performed by the determining unit 26a in the second concrete example will be explained by referring to the flowchart of FIG. 11.

First, in step ST31, the determining unit 26a selects one scheduled action (in the flowchart, a “first scheduled action”) out of the scheduled actions included in the action plan information.

Then, in step ST32, the determining unit 26a specifies, in the first travel route, a route section in which the vehicle is scheduled to travel within the action scheduled time zone associated with the scheduled action selected in step ST31.

Then, in step ST33, the determining unit 26a extracts, out of the vibration points in the first travel route, the vibration points located within the route section specified in step ST32.

Then, in step ST34, the determining unit 26a compares the vibration level value of each of the vibration points extracted in step ST33 with the bypass determination value corresponding to the action type associated with the scheduled action selected in step ST31.

Then, in step ST35, the determining unit 26a compares the vibration occurrence probability value of each of the vibration points extracted in step ST33 with a predetermined value (e.g., 50%) by using the adjustment information included in the vibration point information in the first travel route.

Then, in step ST36, when results of the comparisons in steps ST34 and ST35 show that there exists a vibration point having a vibration level value equal to or greater than the bypass determination value and having a vibration occurrence probability value equal to or greater than the predetermined value, the determining unit 26a determines that the vibration point is a point to be bypassed. At this time, the determining unit 26a determines that any vibration point having a vibration level value less than the bypass determination value and any vibration point having a vibration occurrence probability value less than the predetermined value are not points to be bypassed.

Then, in step ST37, the determining unit 26a determines whether there remain one or more scheduled actions that have not been selected, in the scheduled actions included in the action plan information.

When there remain one or more scheduled actions that have not been selected (“YES” in step ST37), the determining unit 26a , in step ST38, selects one scheduled action (in the flowchart, the “next scheduled action”) out of the scheduled actions that have not been selected. After that, the determining unit 26a performs the processes of steps ST32 to ST36 on the scheduled action selected in step ST38.

In contrast, when all the scheduled actions have been selected (“NO” in step ST37), the processing by the determining unit 26a is ended.

Because the number of points to be bypassed can be reduced by using the adjustment information in this way, increase in the travel time to the destination can be suppressed. More specifically, while increase in the travel time because of bypassing of many vibration points is suppressed, reduction in the comfortableness, the working efficiency, or the like at the time of an action in the vehicle because of vibrations can be prevented.

The determination by the determining unit 26a may be any of determination of “whether or not . . . is equal to or greater than . . . , or less than . . . ” and determination of “whether or not . . . is greater than (higher than) . . . , or equal to or less than . . . .” More specifically, in the second concrete example, when, for each scheduled action included in the action plan information, there exists a vibration point that causes vibrations to occur with a probability higher than the predetermined probability, and that causes the vibrations having a vibration level greater than the bypass determination value that is set in accordance with the action type associated with the scheduled action to occur in the self-driving vehicle 1 at a time within the action scheduled time zone associated with the scheduled action, the determining unit 26a may determine that the vibration point is a point to be bypassed. More concretely, when results of the comparisons in steps ST34 and ST35 show that there exists a vibration point having a vibration level value greater than the bypass determination value and having a vibration occurrence probability value greater than the predetermined value, the determining unit 26a may determine that the vibration point is a point to be bypassed. The term “a probability equal to or higher than the predetermined probability” described in the claims of this application includes not only the meaning of “a probability equal to or higher than the predetermined probability” but also the meaning of “a probability higher than the predetermined probability.”

Further, the predetermined probability in the second concrete example is not limited to 50%, and may be set to any value. Further, the predetermined probability may be set to a value different for each action type.

Further, various modifications similar to those explained in Embodiment 1 can be applied to the route searching device 100a. For example, the route searching device 100a may be disposed in a server device 7, like that in the example shown in FIG. 7.

As mentioned above, in the route searching device 100a of Embodiment 2 , the determining unit 26a determines whether there is a point to be bypassed by using, in addition to the action plan information and the vibration point information, the adjustment information different from both the action plan information and the vibration point information. By using the adjustment information, the number of points to be bypassed can be reduced, and thereby increase in the travel time to the destination can be suppressed.

Further, the action plan information represents the action type and the action scheduled time zone of each scheduled action, the vibration point information represents the position and the vibration level of each vibration point, and the adjustment information represents, for each action type, whether or not measures can be taken against vibrations. When, for each scheduled action associated with an action type in which no measures can be taken against vibrations, there exists a vibration point that causes vibrations having a vibration level equal to or greater than the bypass determination value that is set in accordance with the action type to occur in the self-driving vehicle 1 at a time within the action scheduled time zone, the determining unit 26a determines that the vibration point is a point to be bypassed. In short, it is possible to determine whether there is a point to be bypassed using the adjustment information through the processing exemplified in FIG. 10.

Further, the action plan information represents the action type and the action scheduled time zone of each scheduled action, the vibration point information represents the position and the vibration level of each vibration point, and the adjustment information represents the probability of occurrence of vibrations at each vibration point. When, for each scheduled action, there exists a vibration point that causes vibrations to occur with a probability equal to or higher than the predetermined probability, and that causes the vibrations having a vibration level equal to or greater than the bypass determination value that is set in accordance with the action type to occur in the self-driving vehicle 1 at a time within the action scheduled time zone, the determining unit 26a determines that the vibration point is a point to be bypassed. In short, it is possible to determine whether there is a point to be bypassed using the adjustment information through the processing exemplified in FIG. 11.

### Embodiment 3

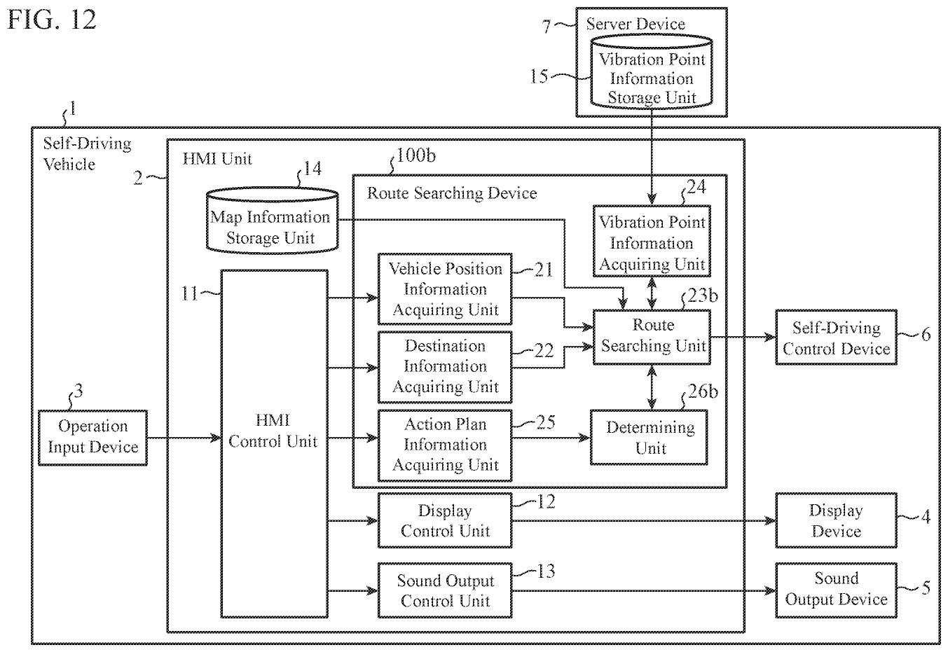

FIG. 12 is a block diagram showing a state in which a route searching device according to Embodiment 3 is disposed in an HMI unit used for a self-driving vehicle. Referring to FIG. 12, the route searching device 100b of Embodiment 3 will be explained by focusing on an example in which the route searching device is disposed in the HMI unit 2 used for the self-driving vehicle 1. In FIG. 12, the same blocks as those shown in FIG. 1 are denoted by the same reference signs, and an explanation of the blocks will be omitted hereinafter.

A determining unit 26b has a function of determining whether there is a point to be bypassed without using adjustment information, like the determining unit 26 shown in FIG. 1. Further, the determining unit 26b has a function of determining whether there is a point to be bypassed by using adjustment information, like the determining unit 26a shown in FIG. 8.

A route searching unit 23b has a function of searching for a first travel route, like the route searching unit 23 shown in FIGS. 1 and 8. Further, the route searching unit 23b has a function of searching for a second travel route that bypasses a point to be bypassed that is specified without using the adjustment information (referred to as an “unadjusted second travel route” hereinafter) , like the route searching unit 23 shown in FIG. 1. In addition, the route searching unit 23b has a function of searching for a second travel route that bypasses a point to be bypassed that is specified using the adjustment information (referred to as an “adjusted second travel route” hereinafter), like the route searching unit 23 shown in FIG. 8.

Main units of the route searching device 100b include a vehicle position information acquiring unit 21, a destination information acquiring unit 22, the route searching unit 23b , a vibration point information acquiring unit 24, an action plan information acquiring unit 25, and the determining unit 26b.

By disposing the determining unit 26b and the route searching unit 23b that are mentioned above, it becomes possible to implement various processes. Hereinafter, three concrete examples of processing that can be implemented by disposing the determining unit 26b and the route searching unit 23b will be explained.

### (First Concrete Example)

First, the route searching unit 23b searches for a first travel route. Then, the determining unit 26b determines whether there is a point to be bypassed without using the adjustment information, and, when it is determined that there is a point to be bypassed, the route searching unit 23b searches for an unadjusted second travel route. Then, the determining unit 26b determines whether there is a point to be bypassed by using the adjustment information, and, when it is determined that there is a point to be bypassed, the route searching unit 23b searches for an adjusted second travel route.

A display control unit 12 causes a display device 4 to display an image showing the travel routes searched for by the route searching unit 23b , out of the first travel route, the unadjusted second travel route, and the adjusted second travel route. An occupant selects one travel route out of these travel routes by using an operation input device 3. The route searching unit 23b outputs route information representing the selected travel route to a self-driving control device 6.

### (Second Concrete Example)

First, the route searching unit 23b searches for a first travel route. Then, the determining unit 26b determines whether there is a point to be bypassed without using the adjustment information. When it is determined that there is no point to be bypassed, the route searching unit 23b outputs route information representing the first travel route to the self-driving control device 6.

When it is determined that there is a point to be bypassed, the route searching unit 23b searches for an unadjusted second travel route. Then, the route searching unit 23b calculates both the estimated time of arrival at the destination when the self-driving vehicle 1 travels along the first travel route, and the estimated time of arrival at the destination when the self-driving vehicle 1 travels along the unadjusted second travel route, and calculates the time difference between these estimated times of arrival. The route searching unit 23b determines whether or not the calculated time difference is equal to or greater than a predetermined time. This predetermined time may be stored in the route searching unit 23b in advance, or may be set through an operation on the operation input device 3. When the calculated time difference is less than the predetermined time, the route searching unit 23b outputs route information representing the unadjusted second travel route to the self-driving control device 6.

When the calculated time difference is equal to or greater than the predetermined time, the route searching unit 23b orders the determining unit 26b to determine whether there is a point to be bypassed by using the adjustment information. The determining unit 26b determines whether there is a point to be bypassed by using the adjustment information in accordance with the order from the route searching unit 23b. When it is determined that there is no point to be bypassed, the route searching unit 23b outputs route information representing the unadjusted second travel route to the self-driving control device 6.

When it is determined that there is no point to be bypassed, the route searching unit 23b may notify an HMI control unit 11 that an adjusted second travel route has not been able to be searched for, instead of outputting route information representing the unadjusted second travel route to the self-driving control device 6. The HMI control unit 11 may order the display control unit 12 to cause the display device 4 to display a screen for urging reinput of an action plan. More specifically, it is considered that when it is impossible to shorten the travel time by means of an adjusted second travel route searched for, any travel route is improper for an occupant. As a result, it is considered that it is better to revise the original action plan.

When it is determined that there is a point to be bypassed, the route searching unit 23b searches for an adjusted second travel route. The route searching unit 23b outputs route information representing the adjusted second travel route to the self-driving control device 6.

### (Third Concrete Example)

First, the route searching unit 23b searches for a first travel route. The display control unit 12 causes the display device 4 to display an image showing the first travel route. An occupant selects the necessity or unnecessity of a search for a travel route different from the first travel route (more concretely, an unadjusted second travel route) by using the operation input device 3. When the “unnecessity” of a search for an unadjusted second travel route is selected, the route searching unit 23b outputs route information representing the first travel route to the self-driving control device 6.

When the “necessity” of a search for an unadjusted second travel route is selected, the determining unit 26b determines whether there is a point to be bypassed without using the adjustment information. When it is determined that there is no point to be bypassed, the route searching unit 23b outputs route information representing the first travel route to the self-driving control device 6.

When it is determined that there is a point to be bypassed, the route searching unit 23b searches for an unadjusted second travel route. The display control unit 12 causes the display device 4 to display an image showing the unadjusted second travel route. The occupant selects the necessity or unnecessity of a search for a travel route different from the unadjusted second travel route (more concretely, an adjusted second travel route) by using the operation input device 3. When the “unnecessity” of a search for an adjusted second travel route is selected, the route searching unit 23b outputs route information representing the unadjusted second travel route to the self-driving control device 6.

When the “necessity” of a search for an adjusted second travel route is selected, the determining unit 26b determines whether there is a point to be bypassed by using the adjustment information. When it is determined that there is no point to be bypassed, the route searching unit 23b outputs route information representing the unadjusted second travel route to the self-driving control device 6.

When it is determined that there is no point to be bypassed, the route searching unit 23b may notify the HMI control unit 11 that an adjusted second travel route has not been able to be searched for, instead of outputting route information representing the unadjusted second travel route to the self-driving control device 6. The HMI control unit 11 may order the display control unit 12 to cause the display device 4 to display a screen for urging reinput of an action plan. The reason for this is as mentioned above.

When it is determined that there is a point to be bypassed, the route searching unit 23b searches for an adjusted second travel route. The route searching unit 23b outputs route information representing the adjusted second travel route to the self-driving control device 6.

Various modifications similar to those explained in Embodiments 1 and 2 can be applied to the route searching device 100b. For example, the route searching device 100b may be disposed in a server device 7, like that in the example shown in FIG. 7.

As mentioned above, in the route searching device 100b of Embodiment 3 , the determining unit 26b has the function of determining whether there is a point to be bypassed without using the adjustment information, and the function of determining whether there is a point to be bypassed by using the adjustment information, and the route searching unit 23b has the function of searching for an unadjusted second travel route bypassing a point to be bypassed that is specified without using the adjustment information, and the function of searching for an adjusted second travel route bypassing a point to be bypassed that is specified using the adjustment information. As a result, it becomes possible to implement the various processes as shown in the first through third concrete examples.

It is to be understood that any combination of two or more of the above-mentioned embodiments can be made, various changes can be made in any component according to any one of the above-mentioned embodiments, and any component according to any one of the above-mentioned embodiments can be omitted within the scope of the present disclosure.

### INDUSTRIAL APPLICABILITY

The route searching device of the present disclosure can be used for a search for a travel route for self-driving vehicles.

### REFERENCE SIGNS LIST

1 self-driving vehicle, 2 HMI unit, 3 operation input device, 4 display device, 5 sound output device, 6 self-driving control device, 7 server device, 11 HMI control unit, 12 display control unit, 13 sound output control unit, 14 map information storage unit, 15 vibration point information storage unit, 21 vehicle position information acquiring unit, 22 destination information acquiring unit, 23, 23b route searching unit, 24 vibration point information acquiring unit, 25 action plan information acquiring unit, 26, 26a , 26b determining unit, 31 processor, 32 memory, 33 processing circuit, and 100, 100a , 100b route searching device.

1. A route searching device that searches for a travel route for a self-driving vehicle, the route searching device comprising:
processing circuitry to search for a first travel route;
to acquire action plan information for an occupant in the vehicle;
to acquire vibration point information in the first travel route;
to determine whether there is a point to be bypassed among one or more vibration points in the first travel route by using the action plan information and the vibration point information; and
when it is determined that there is a point to be bypassed, to search for a second travel route bypassing the point to be bypassed.

2. The route searching device according to claim 1, wherein the action plan information represents an action type and an action scheduled time zone both of which one or more scheduled actions each have,
the vibration point information represents a position and a vibration level of each of the vibration points, and
when, for each of the scheduled actions, there exists one of the vibration points that causes vibrations having a vibration level equal to or greater than a bypass determination value set in accordance with the action type to occur in the self-driving vehicle at a time within the action scheduled time zone, the processing circuitry determines that the one of the vibration points is the point to be bypassed.

3. The route searching device according to claim 1, wherein the action plan information represents an action type and an action scheduled time zone both of which one or more scheduled actions each have,
the vibration point information represents a position and a vibration level of each of the vibration points, and
when, for each of the scheduled actions, there exist in the vibration points two or more vibration points that cause vibrations having vibration levels equal to or greater than a bypass determination value set in accordance with the action type to continuously occur in the self-driving vehicle over a predetermined time period within the action scheduled time zone, the processing circuitry determines that each of the two or more vibration points is the point to be bypassed.

4. The route searching device according to claim 1, wherein the processing circuitry determines whether there is a point to be bypassed by using, in addition to the action plan information and the vibration point information, adjustment information different from both the action plan information and the vibration point information.

5. The route searching device according to claim 4, wherein the action plan information represents an action type and an action scheduled time zone both of which one or more scheduled actions each have,
the vibration point information represents a position and a vibration level of each of the vibration points,
the adjustment information represents, for the action type, whether a measure can be taken against vibrations, and
with respect to scheduled actions associated with an action type in which no measure can be taken against vibrations, when, for each of the associated scheduled actions, there exists one of the vibration points that causes vibrations having a vibration level equal to or greater than a bypass determination value set in accordance with the action type to occur in the self-driving vehicle at a time within the action scheduled time zone, the processing circuitry determines that the one of the vibration points is the point to be bypassed.

6. The route searching device according to claim 4, wherein the action plan information represents an action type and an action scheduled time zone both of which one or more scheduled actions each have,
the vibration point information represents a position and a vibration level of each of the vibration points,
the adjustment information represents a probability of occurrence of vibrations at each of the vibration points, and
when, for each of the scheduled actions, there exists one of the vibration points that causes vibrations to occur with a probability equal to or higher than a predetermined probability, and that causes the vibrations having a vibration level equal to or greater than a bypass determination value set in accordance with the action type to occur in the self-driving vehicle at a time within the action scheduled time zone, the processing circuitry determines that the one of the vibration points is the point to be bypassed.

7. A route searching system that searches for a travel route for a self-driving vehicle, the route searching system comprising:
processing circuitry
to search for a first travel route;
to acquire action plan information for an occupant in the vehicle;
to acquire vibration point information in the first travel route;
to determine whether there is a point to be bypassed among one or more vibration points in the first travel route by using the action plan information and the vibration point information; and
when it is determined that there is a point to be bypassed, to search for a second travel route bypassing the point to be bypassed.

8. A route searching method of searching for a travel route for a self-driving vehicle, the route searching method comprising:
searching for a first travel route;
acquiring action plan information for an occupant in the vehicle;
acquiring vibration point information in the first travel route;
determining whether there is a point to be bypassed among one or more vibration points in the first travel route by using the action plan information and the vibration point information; and
when it is determined that there is a point to be bypassed, searching for a second travel route bypassing the point to be bypassed.
